(19) United States
(12) Patent Application Publication
(10) Pub. No.: US 2004/0195355 A1
(43) Pub. Date: Oct. 7, 2004

(54) Bead-type hot melt adhesive dispensing nozzle with thermal protective ring

(75) Inventors: Edward W. Bolyard JR., Old Hickory, TN (US); Paul J. Donley, Hendersonville, TN (US); George Hoff, Florence, KY (US)

Correspondence Address: Steven W. Weinrieb, SCHWARTZ & WEINRIEB, Crystal Plaza One, 2001 Jefferson Davis Highway, Suite 1109, Arlington, VA, 22202, US

(73) Assignee: ILLINOIS TOOL WORKS INC.

(21) Appl. No.: 10/374,988

(22) Filed: Feb. 28, 2003

(51) Int. Cl. B05C 1/00; B05B 1/24; B05B 7/16; F23D 11/44

(52) U.S. Cl. 239/128; 239/397.5; 239/525; 239/526

(57) ABSTRACT

A new and improved bead-type hot melt adhesive dispensing nozzle, and a new and improved bead-type hot melt adhesive applicator nozzle assembly having the new and improved bead-type hot melt adhesive dispensing nozzle operatively incorporated thereon, is disclosed wherein the external peripheral surface portion of the bead-type hot melt adhesive dispensing nozzle has a thermal protective ring member, fabricated from a suitable plastic material, such as, for example, polyetheretherketone (PEEK), fixedly mounted thereon. In this manner, maintenance or operator personnel can manually manipulate the bead-type hot melt adhesive dispensing nozzle without being exposed to potential burn and safety hazards. In addition, the need for such operator or maintenance personnel to wear heavy, bulky, or cumbersome gloves is obviated, and consequently, the operator or maintenance personnel can readily, rapidly, easily, and safely manually remove, for example, clogged bead-type hot melt adhesive dispensing nozzles from the bead-type hot melt adhesive applicator nozzle assemblies, and install new bead-type hot melt adhesive dispensing nozzles onto the bead-type hot melt adhesive applicator nozzle assemblies, in accordance with required or desired bead-type hot melt adhesive dispensing nozzle maintenance replacement or operational exchange procedures.

### FIELD OF THE INVENTION

The present invention relates generally to hot melt adhesive applicators, and more particularly to a new and improved bead-type hot melt adhesive dispensing nozzle, wherein the new and improved bead-type hot melt adhesive dispensing nozzle has a thermal protective ring member fixedly mounted upon an outer peripheral surface of the dispensing nozzle, such as, for example, by means of a press fit or other similar fixation process, so as to enable the mounting and dismounting operations of the bead-type hot melt adhesive dispensing nozzle, onto and off from a hot melt adhesive material module assembly, to be performed in a relatively quick, easy, and safe manner, and wherein further, the thermal protective ring member, fixedly mounted upon the outer peripheral surface portion of the dispensing nozzle, serves to thermally protect operator personnel from excessive heat and potential burn hazards when, for example, the operator personnel perform mounting and/or dismounting operations of the bead-type hot melt adhesive dispensing nozzles, onto and off from the hot melt adhesive material module assemblies, in accordance with bead-type hot melt adhesive dispensing nozzle replacement or exchange operations attendant maintenance procedures or the implementation of different hot melt adhesive deposition requirements.

### BACKGROUND OF THE INVENTION

In the hot melt adhesive dispensing industry, generally two different types of hot melt adhesive dispensing nozzles are well-known. More particularly, a first type of hot-melt adhesive dispensing nozzle which is well-known in the hot melt adhesive dispensing industry is the swirl-type or spiral-type hot melt adhesive dispensing nozzle wherein, for example, a plurality of substantially axially oriented air passageways are provided in a substantially circumferential array around the axially located dispensing nozzle discharge port for effectively conducting swirl or spiral air currents therethrough for operative fluidic interaction with the dispensed hot melt adhesive material so as to affect or control the particularly desired deposition pattern of the hot melt adhesive material being dispensed. Examples of such swirl-type or spiral-type hot melt adhesive dispensing nozzles are disclosed, for example, within U.S. Pat. No. 6,149,076 which issued to Riney on Nov. 21, 2000, U.S. Pat. No. 5,292,068 which issued to Raterman et al. on Mar. 8, 1994, and U.S. Pat. No. 4,785,996 which issued to Ziecker et al. on Nov. 22, 1988.

The second type of hot-melt adhesive dispensing nozzle which is well-known in the hot melt adhesive dispensing industry is the bead-type hot melt adhesive dispensing nozzle wherein, for example, the nozzle member comprises a forwardly disposed substantially planar plate or disk portion or member from which an axially located dispensing nozzle discharge port projects axially forwardly from the sub-stantially planar plate or disk portion or member in order to deposit hot melt adhesive material in the form of beads onto particular substrates. As is often the case with the first spiral-type or swirl-type hot melt adhesive dispensing nozzle, wherein a particular hot melt adhesive dispensing nozzle needs to be periodically replaced or changed either for maintenance purposes or to alter the deposition pattern of the hot melt adhesive material being dispensed onto a particular substrate, the second bead-type hot melt adhesive dispensing nozzle likewise needs to be periodically replaced or changed either for maintenance purposes, or to alter the characteristics of either the bead of the hot melt adhesive material being dispensed or deposited onto the particular substrate, or the characteristics of the hot melt adhesive material dispensing or deposition operation or process in accordance with the implementation of different hot melt adhesive deposition requirements.

More particularly, after a typical bead-type hot melt adhesive dispensing nozzle has been used to perform a predetermined or multiple number of hot melt adhesive dispensing operations, the hot melt adhesive dispensing nozzle discharge port of the bead-type hot melt adhesive dispensing nozzle will sometimes tend to become clogged. Accordingly, the particular clogged hot melt adhesive dispensing nozzle must be removed or dismounted from the hot melt adhesive material module assembly, and a new hot melt adhesive dispensing nozzle must be replaced or mounted upon the hot melt adhesive material module assembly. Alternatively, it is sometimes desired to exchange bead-type hot melt adhesive dispensing nozzles in order to alter, for example, the particular size of the hot melt adhesive dispensing nozzle discharge port of the bead-type hot melt adhesive dispensing nozzle so as to, in turn, alter the size of the hot melt adhesive material bead being dispensed and deposited onto a particular substrate. Such bead-type hot melt adhesive dispensing nozzles have been adapted to be manually removed, installed, replaced, or exchanged by maintenance or operator personnel without the use of or need for special tools, however, these operations have not always been able to be readily achieved in a relatively rapid, easy, and safe manner.

For example, in view of the fact that such bead-type hot melt adhesive dispensing nozzles are being used to dispense hot melt adhesive material, the bead-type hot melt adhesive dispensing nozzles are necessarily fabricated from a suitable metal, such as, for example, brass, which will exhibit high thermal conductivity. However, in view of such high thermal conductivity, and in view of the high temperature level characteristic of the hot melt adhesive material being dispensed, the maintenance or operator personnel must wear heavy, cumbersome, bulky gloves in order to protect themselves from potential burn hazards when handling the bead-type hot melt adhesive dispensing nozzles and yet still be cap-able of manually manipulating the bead-type hot melt adhesive dispensing nozzles in accordance with the desired procedures attendant the installation or removal of the bead-type hot melt adhesive dispensing nozzles without requiring the use of special tooling.

A need therefore exists in the art for a new and improved bead-type hot melt adhesive dispensing nozzle, and a new and improved bead-type hot melt adhesive applicator nozzle assembly having the new and improved bead-type hot melt adhesive dispensing nozzle operatively incorporated therein, wherein the bead-type hot melt adhesive dispensing nozzle can be provided with suitable thermal protective means so as to effectively rid the bead-type hot melt adhesive applicator nozzle assembly of potential burn and safety hazards to maintenance or operator personnel whereby the maintenance or operator personnel can readily, rapidly, easily, and safely remove and install such bead-type hot melt adhesive dispensing nozzles from and onto the bead-type hot melt adhesive applicator nozzle assemblies in accordance with required or desired bead-type hot melt adhesive dispensing nozzle maintenance replacement or operational exchange procedures.

### OBJECTS OF THE INVENTION

Accordingly, it is an object of the present invention to provide a new and improved bead-type hot melt adhesive dispensing nozzle, and a new and improved bead-type hot melt adhesive applicator nozzle assembly having the new and improved bead-type hot melt adhesive dispensing nozzle operatively incorporated therein.

Another object of the present invention is to provide a new and improved bead-type hot melt adhesive dispensing nozzle, and a bead-type hot melt adhesive applicator nozzle assembly having the new and improved bead-type hot melt adhesive dispensing nozzle operatively incorporated therein, which effectively overcomes the various structural and operational drawbacks and disadvantages characteristic of the PRIOR ART bead-type hot melt adhesive dispensing nozzles and hot melt adhesive applicator nozzle assemblies.

An additional object of the present invention is to provide a new and improved bead-type hot melt adhesive dispensing nozzle, and a new and improved bead-type hot melt adhesive applicator nozzle assembly having the new and improved bead-type hot melt adhesive dispensing nozzle operatively incorporated therein, wherein the external peripheral surface portion of the bead-type hot melt adhesive dispensing nozzle has a thermal protective ring member, fabricated from a suitable plastic material, fixedly mounted thereon so as to effectively rid the bead-type hot melt adhesive dispensing nozzle, and the bead-type hot melt adhesive applicator nozzle assembly, of potential burn and safety hazards to maintenance or operator personnel.

A further object of the present invention is to provide a new and improved bead-type hot melt adhesive dispensing nozzle, and a new and improved bead-type hot melt adhesive applicator nozzle assembly having the new and improved bead-type hot melt adhesive dispensing nozzle operatively incorporated therein, wherein the external peripheral surface portion of the bead-type hot melt adhesive dispensing nozzle has a thermal protective ring member, fabricated from a suitable plastic material, fixedly mounted thereon so as to effectively rid the bead-type hot melt adhesive dispensing nozzle, and the bead-type hot melt adhesive applicator nozzle assembly, of potential burn and safety hazards to maintenance or operator personnel, and in addition, to obviate the need for such maintenance or operator personnel to wear heavy, bulky, or cumbersome gloves during the performance of nozzle maintenance or exchange operations.

A last object of the present invention is to provide a new and improved bead-type hot melt adhesive dispensing nozzle, and a new and improved bead-type hot melt adhesive applicator nozzle assembly having the new and improved bead-type hot melt adhesive dispensing nozzle operatively incorporated thereon, wherein the external peripheral surface portion of the bead-type hot melt adhesive dispensing nozzle has a thermal protective ring member, fabricated from a suitable plastic material, fixedly mounted thereon so as to effectively rid the bead-type hot melt adhesive dispensing nozzle, and the bead-type hot melt adhesive applicator nozzle assembly, of potential burn and safety hazards to operator or maintenance personnel, and in addition, to obviate the need for such maintenance or operator personnel to wear heavy, bulky, or cumbersome gloves whereby the maintenance or operator personnel can readily, rapidly, easily, and safely remove and install such bead-type hot melt adhesive dispensing nozzles from and onto the bead-type hot melt adhesive applicator nozzle assemblies in accordance with required or desired bead-type hot melt adhesive dispensing nozzle maintenance replacement or operational exchange procedures

### SUMMARY OF THE INVENTION

The foregoing and other objectives are achieved in accordance with the teachings and principles of the present invention through the provision of a new and improved bead-type hot melt adhesive dispensing nozzle, and a new and improved bead-type hot melt adhesive applicator nozzle assembly having the new and improved bead-type hot melt adhesive dispensing nozzle operatively incorporated thereon, wherein the external peripheral surface portion of the bead-type hot melt adhesive dispensing nozzle has a thermal protective ring member, fabricated from a suitable plastic material, such as, for example, a polyetheretherketone (PEEK) polymer, fixedly mounted thereon. In this manner, maintenance or operator personnel can manually manipulate the bead-type hot melt adhesive dispensing nozzle without being exposed to potential burn and safety hazards. In addition, the need for such operator or maintenance personnel to wear heavy, bulky, or cumbersome gloves is obviated, and consequently, the operator or maintenance personnel can readily, rapidly, easily, and safely manually remove, for example, clogged bead-type hot melt adhesive dispensing nozzles from the bead-type hot melt adhesive applicator nozzle assemblies, and install new bead-type hot melt adhesive dispensing nozzles onto the bead-type hot melt adhesive applicator nozzle assemblies, in accordance with required or desired bead-type hot melt adhesive dispensing nozzle maintenance replacement or operational exchange procedures.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding arts throughout the several views, and wherein:

FIG. 1 is a perspective view of a new and improved bead-type hot melt adhesive dispensing nozzle constructed in accordance with the principles and teachings of the present invention and showing the cooperative parts thereof;

FIG. 2 is a cross-sectional view of the new and improved bead-type hot melt adhesive dispensing nozzle of the present invention, as disclosed within FIG. 1 and as taken along lines 2-2 of FIG. 1; and

FIG. 3 is a cross-sectional view of a new and improved bead-type hot melt adhesive applicator nozzle assembly, having the new and improved bead-type hot melt adhesive dispensing nozzle, as disclosed within FIG. 2, operatively incorporated thereon.

### DETAILED DESCRIPTION OF THE ILLUSTRATED EMBODIMENTS

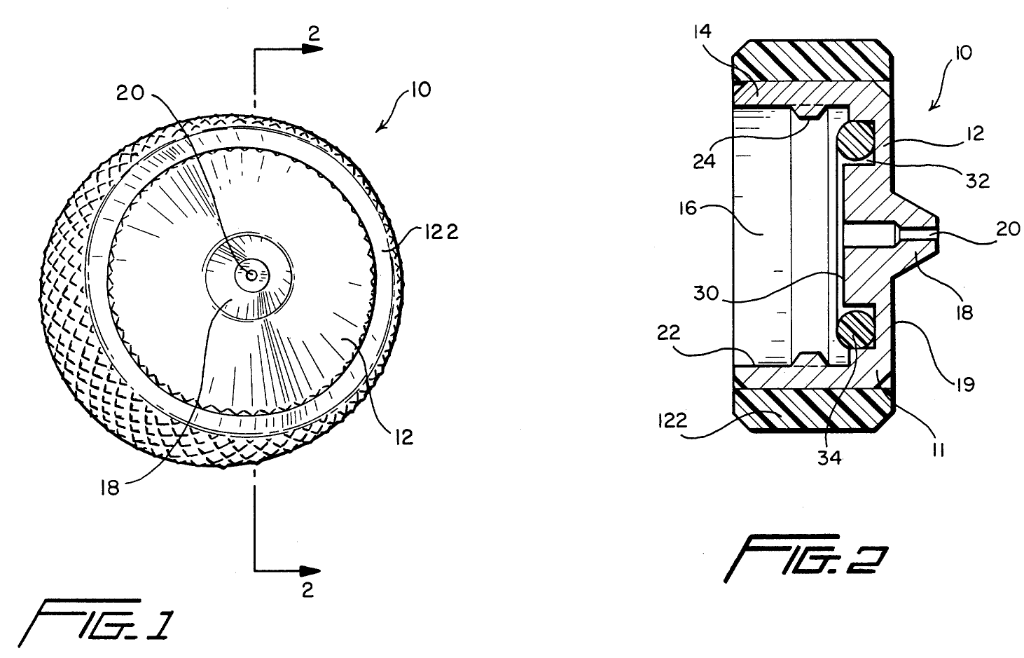

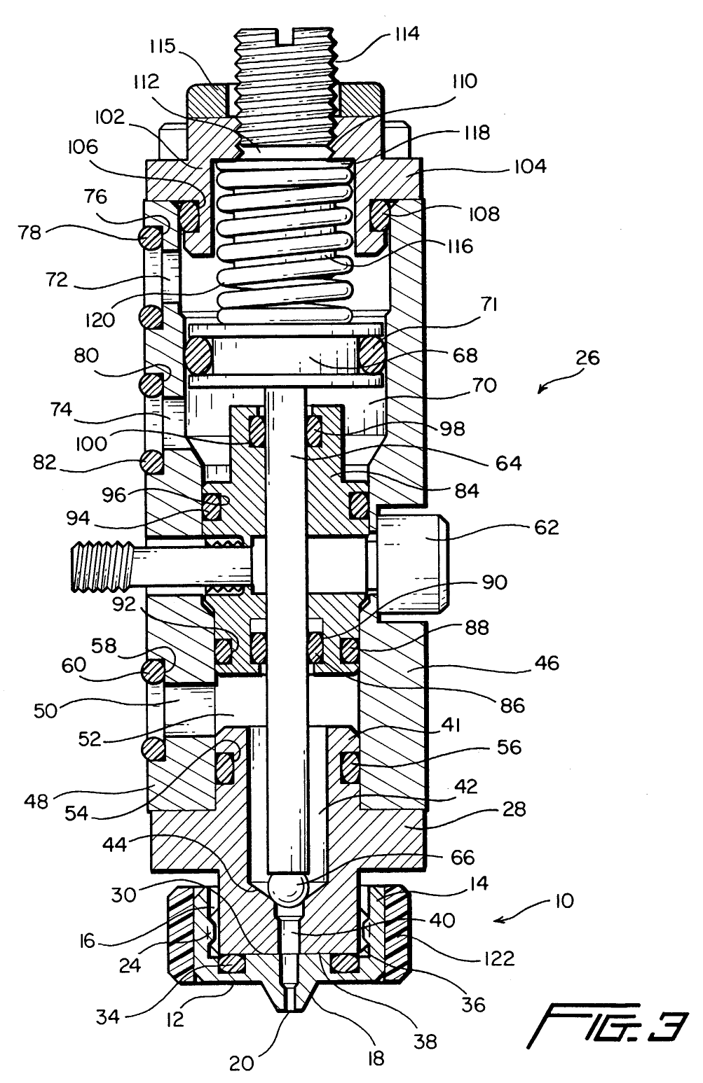

Referring now to the drawings, and more particularly to FIGS. 1 and 2 thereof, a new and improved hot melt adhesive dispensing nozzle, constructed in accordance with the principles and teachings of the present invention, is disclosed and is generally indicated by the reference character 10. More particularly, as can best be appreciated from FIG. 2, it is seen that the new and improved hot melt adhesive dispensing nozzle 10 comprises a substantially cup-shaped member 11 which, in turn, is comprised of a substantially planar front plate 12 and a rearwardly extending tubular wall member 14 whereby such rearwardly extending tubular wall member 14 and the substantially planar front plate 12 together define an internal cavity 16. A hot melt adhesive dispensing nozzle discharge port housing 18, having a substantially frusto-conical configuration, projects axially forwardly from the front face 19 of the substantially planar front face plate 12, and an axially oriented hot melt adhesive dispensing nozzle discharge or dispensing port 20 is defined within the hot melt adhesive dispensing nozzle discharge port housing 18 so as to permit hot melt adhesive material to be discharged or dispensed therefrom in the form of a bead. The inner peripheral wall surface 22 of the tubular wall member 14 is provided with an annular threaded region 24 by means of which the new and improved hot melt adhesive dispensing nozzle 10 is adapted to be threadedly mounted upon a new and improved bead-type hot melt adhesive applicator nozzle assembly which is disclosed and generally indicated by the reference character 26 in FIG. 3. In this manner, the new and improved bead-type hot melt adhesive dispensing nozzle 10 of the present invention is able to be integrally incorporated within or upon the new and improved bead-type hot melt adhesive applicator nozzle assembly 26 of the present invention.

With reference now being specifically made to FIG. 3, a detailed description of the new and improved bead-type hot melt adhesive applicator nozzle assembly 26, having the new and improved hot melt adhesive dispensing nozzle 10 integrally incorporated thereon, will be described. More particularly, as can be appreciated from FIG. 3, the new and improved bead-type hot melt adhesive applicator nozzle assembly 26 of the present invention comprises a valve seat member 28 which is seen to have a substantially +-shaped cross-sectional configuration. The rear face portion 30 of the substantially planar front plate 12 of the hot melt adhesive dispensing nozzle 10 is provided with an annular recess 32, and an O-ring sealing member 34 is disposed within the annular recess 32 as best seen in FIG. 2. The forward or lower end portion of the valve seat member 28 of the bead-type hot melt adhesive applicator nozzle assembly 26 has an external threaded region 36 formed upon the outer periphery thereof so as to enable the internal annular threaded region 24 of the hot melt adhesive dispensing nozzle 10 to be threadedly engaged therewith whereby the hot melt adhesive dispensing nozzle 10 is fixedly and securely mounted upon the valve seat member 28 of the bead-type hot melt adhesive applicator nozzle assembly 26. Accordingly, when such valve seat member 28 and hot melt adhesive dispensing nozzle 10 components are in fact fully threaded together, it is appreciated that the forward or lower end portion of the valve seat member 28 will be fully disposed or seated within the internal cavity 16 of the hot melt adhesive dispensing nozzle 10, a forward or lower face portion 38 of the valve seat member 28 will be disposed in engaged contact with or seated upon the rear or upper face portion 30 of the substantially planar front plate 12 of the hot melt adhesive dispensing nozzle 10, and the annular O-ring sealing member 34 will be compressed within its annular recess 32 so as to perform its sealing function.

With reference continuing to be made to FIG. 3, it is further seen that the forward or lower end portion of the valve seat member 28 is provided with an axially oriented hot melt adhesive output passage or conduit 40 which is adapted to be coaxially aligned with and fluidically connected to the axially oriented hot melt adhesive dispensing nozzle discharge or dispensing port 20 defined within the hot melt adhesive dispensing nozzle 10, and the rearward or upper end portion 41 of the valve seat member 28 is provided with an axially oriented hot melt adhesive intake bore and accumulation chamber 42 which is likewise adapted to be coaxially aligned with and fluidically connected to the hot melt adhesive output passage or conduit 40. It is further appreciated or noted that the axially oriented hot melt adhesive intake bore and accumulation chamber 42 has a diametrical extent which is substantially larger than that of the hot melt adhesive output passage or conduit 40, and a radially convergent region is formed between the substantially large diameter hot melt adhesive intake bore and accumulation chamber 42 and the smaller diameter hot melt adhesive output passage or conduit 40 so as to effectively define a valve seat 44 at the interface between the substantially large hot melt adhesive intake bore and accumulation chamber 42 and the smaller diameter hot melt adhesive output passage or conduit 40.

The valve seat member 28 is adapted to be fixedly mounted upon the forward or lower end portion of a tubular body member 46 of the bead-type hot melt adhesive applicator nozzle assembly 26 by any suitable means, not shown, such that the rearward or upper end portion 41 of the valve seat member 28 is disposed within the forward or lower open end portion 48 of the tubular body member 46 of the bead-type hot melt adhesive applicator nozzle assembly 26. The forward or lower open end portion 48 of the tubular body member 46 is also provided with a radially oriented supply port 50 for supplying hot melt adhesive material from a suitable hot melt adhesive supply manifold, not shown, into the interior space 52 of the tubular body member 46, and in this manner, the supplied hot melt adhesive material can, in turn, be supplied to the hot melt adhesive intake bore and accumulation chamber 42 as a result of the fluidic communication defined between the interior space 52 of the tubular body member 46 and the hot melt adhesive intake bore and accumulation chamber 42. It is further noted that the rearward or upper end portion 41 of the valve seat member 28 is additionally provided with an annular recess 54 within which an O-ring sealing member 56 is disposed, and in this manner, when the rearward or upper end portion 41 of the valve seat member 28 is disposed within the forward or lower open end portion 48 of the tubular body member 46 of the bead-type hot melt adhesive applicator nozzle assembly 26, the outer peripheral surface region of the rearward or upper end portion 41 of the valve seat member 28 is fluidically sealed with respect to the inner peripheral surface region of the forward or lower open end portion 48 of the tubular body member 46 of the bead-type hot melt adhesive applicator nozzle assembly 26. In a similar manner, an annular recess 58 is also defined within the forward or lower open end portion 48 of the tubular body member 46 of the bead-type hot melt adhesive applicator nozzle assembly 26 so as to annularly surround the radially oriented hot melt adhesive material supply port 50, and an O-ring sealing member 60 is adapted to be accommodated and positioned within the recess 58. In this manner, when the bead-type hot melt adhesive applicator nozzle assembly 26 is mounted upon the hot melt adhesive supply manifold, not shown, by means of, for example, suitable able bolt fasteners 62, the interface defined between the bead-type hot melt adhesive applicator nozzle assembly 26 and the hot melt adhesive supply manifold, not shown, will be effectively or properly sealed within the region of the hot melt adhesive material supply port 50.

Continuing further, and with reference still being made to FIG. 3, a valve mechanism, comprising a valve stem 64 and a ball valve member 66 fixedly and integrally disposed upon the lower or forward end of the valve stem 64, is adapted to be vertically movable within the tubular body member 46 such that the valve mechanism can perform its valving function. More particularly, the upper or rearward end of the valve stem 64 is fixedly and integrally connected to a piston member 68, and it is seen that the piston member 68 is adapted to be vertically movable in a reciprocal manner within an upper section of the tubular body member 46 which defines a cylinder chamber 70, the piston member 68 including an annular piston ring 71 for operatively sealing with the interior peripheral wall surface of the upper section of the tubular body member 46 which defines the cylinder chamber 70. The cylinder chamber 70 has a first, radially oriented pneumatic CLOSE control air supply port 72 fluidically connected thereto by means of which pneumatic control air can be supplied at predetermined times in order to move the valve mechanism, comprising the piston member 68, the valve stem 64, and the ball valve member 66, downwardly or forwardly, as a result of such control air impacting upon the upper surface portion of the piston member 68, whereby the ball valve member 66 is adapted to be seated upon the valve seat 44 such that the valve mechanism is moved to its CLOSED position. In a similar manner, the cylinder chamber 70 has a second, radially oriented pneumatic OPEN control air supply port 74 fluidically connected thereto by means of which pneumatic control air can be supplied at predetermined times in order to move the valve mechanism, comprising the piston member 68, the valve stem 64, and the ball valve member 66, upwardly or rearwardly, as a result of such control air impacting upon the undersurface portion of the piston member 68, whereby the ball valve member 66 is adapted to be unseated from the valve seat 44 such that the valve mechanism is moved to its OPENED position.

Accordingly, depending upon the respective actuation and movement of the valve mechanism between its OPENED and CLOSED positions, hot melt adhesive material, supplied from the hot melt adhesive material supply port 50, and disposed within the hot melt adhesive intake bore and accumulation chamber 42, is able to be discharged and dispensed from the hot melt adhesive dispensing nozzle discharge or dispensing port 20 as a result of the ball valve member 66 having been unseated from the valve seat 44, or alternatively, hot melt adhesive material, as supplied from the hot melt adhesive material supply port 50, and disposed within the hot melt adhesive intake bore and accumulation chamber 42, is unable to be discharged and dispensed from the hot melt adhesive dispensing nozzle discharge or dispensing port 20 as a result of the ball valve member 66 having been seated upon the valve seat 44. In a manner similar to the provision or disposition of the hot melt adhesive material supply port 50 within the tubular body member 46 of the bead-type hot melt adhesive applicator nozzle assembly 26, it is likewise seen that an annular recess 76 is defined within the rear ward or upper end portion of the tubular body member 46 of the bead-type hot melt adhesive applicator nozzle assembly 26 so as to annularly surround the first, radially oriented pneumatic CLOSE control air supply port 72, and an O-ring sealing member 78 is adapted to be accommodated and positioned within the annular recess 76. Still further, an annular recess 80 is also defined within the rearward or upper end portion of the tubular body member 46 of the bead-type hot melt adhesive applicator nozzle assembly 26 so as to annularly surround the second, radially oriented pneumatic OPEN control air supply port 74, and an O-ring sealing member 82 is adapted to be accommodated and positioned within the annular recess 80.

In this manner, when the bead-type hot melt adhesive applicator nozzle assembly 26 is mounted upon the hot melt adhesive supply manifold, not shown, by means of, for example, the bolt fasteners 62, the interface defined between the bead-type hot melt adhesive applicator nozzle assembly 26 and the hot melt adhesive supply manifold, not shown, will be effectively or properly sealed within the regions of the first and second pneumatically-controlled, CLOSE and OPEN ports 72,74. It is additionally noted that a seal cartridge 84 is fixedly disposed at a substantially axially intermediate position within the tubular body member 46 of the bead-type hot melt adhesive applicator nozzle assembly 26, and it is noted that the function of the seal cartridge 84 is to effectively ensure the proper routing or containment of the particular fluids, which are operative within the bead-type hot melt adhesive applicator nozzle assembly 26, within predetermined sections of the bead-type hot melt adhesive applicator nozzle assembly 26, or alternatively, to prevent fluid migration of such fluids to other sections of the bead-type hot melt adhesive applicator nozzle assembly 26.

More particularly, for example, it is seen that the lower or forward section of the seal cartridge 84 is provided with first and second, radially inner and radially outer O-ring sealing members 86,88, which are disposed within their respective annular recesses 90,92 which are formed upon the radially inner and radially outer peripheral surface portions of the seal cartridge 84, so as to effectively prevent the fluidic migration of the hot melt adhesive material, as supplied into the bead-type hot melt adhesive applicator nozzle assembly 26 through means of the hot melt adhesive material supply port 50, upwardly or rearwardly either along the valve stem 64 or along the interior peripheral wall surface of the tubular body member 46. In this manner, the hot melt adhesive material, as supplied into the bead-type hot melt adhesive applicator nozzle assembly 26 through means of the hot melt adhesive material supply port 50, is effectively forced to migrate or flow only toward the hot melt adhesive intake bore and accumulation chamber 42 and the hot melt adhesive dispensing nozzle discharge or dispensing port 20.

In a similar manner, it is seen that an axially intermediate portion of the seal cartridge 84 is additionally provided with a third O-ring sealing member 94, which is disposed within an annular recessed portion 96 which is formed upon an outer peripheral surface portion of the seal cartridge 84, while the axially upper or rearward portion of the seal cartridge 84 is similarly provided with a fourth O-ring sealing member 98, which is disposed within an annular recessed portion 100 which is formed upon an inner peripheral surface portion of the seal cartridge 84, so as to effectively prevent the fluidic migration of the pneumatic OPEN control air, as supplied into the bead-type hot melt adhesive applicator nozzle assembly 26 through means of the pneumatic OPEN control air supply port 74, to migrate or flow downwardly or forwardly either along the valve stem 64 or along the interior peripheral wall surface of the tubular body member 46. In this manner, the pneumatic OPEN control air, as supplied into the bead-type hot melt adhesive applicator nozzle assembly 26 through means of the pneumatic OPEN control air supply port 74, is effectively forced to migrate or flow only toward the undersurface portion of the piston member 68 so as to impact the same and cause the upward or rearward movement of the valve mechanism toward its OPENED position.

Lastly, in connection with the various structural components comprising the bead-type hot melt adhesive applicator nozzle assembly 26, it is noted that an annular end cap 102, having a radially outwardly projecting flange portion 104 at the substantially axially central portion thereof, is adapted to be fixedly mounted, by any suitable means, not shown, upon the upper or rearwardly disposed end portion of the tubular body member 46 of the bead-type hot melt adhesive applicator nozzle assembly 26. More particularly, when the annular end cap 102 is mounted upon the upper or rearwardly disposed end portion of the tubular body member 46 of the bead-type hot melt adhesive applicator nozzle assembly 26, the flange portion 104 of the annular end cap 102 will be seated upon the upper or rearwardly disposed open end portion of the tubular body member 46 of the bead-type hot melt adhesive applicator nozzle assembly 26. A lower or forward end portion of the annular end cap 102 has an annular recess 106 formed within the outer peripheral surface thereof, and an O-ring sealing member 108 is disposed within the annular recess 106 so as to effect a seal between the annular end cap 102 and the inner peripheral surface of the upper or rearwardly disposed end portion of the tubular body member 46 of the bead-type hot melt adhesive applicator nozzle assembly 26. The upper or rearwardly disposed end portion of the annular end cap 102 has an internally threaded opening 110 defined therein, and an adjustment screw 112 has an upper or rearwardly disposed threaded shaft section 114 for threaded mating and insertion within the threaded opening 110 of the end cap 102, a nut member 115 also being threadedly engaged with the threaded shaft section 114 of the adjustment screw 112 so as to effectively lock the adjustment screw 112 at a particular adjusted position. The lower or forwardly disposed shaft section 116 of the adjustment screw 112 is unthreaded, and a flanged portion 118 is provided substantially at the interface defined between the upper threaded portion 114 of the adjustment screw 112 and the lower unthreaded shaft section 116 of the adjustment screw 112. A coil spring 120 is mounted upon the adjustment screw 112 so as to be disposed around the lower unthreaded shaft section 116 whereby the upper end portion of the coil spring 120 is disposed in contact with the flanged portion 118 of the adjustment screw 112, while the lower end portion of the coil spring 120 is seated atop the valve mechanism piston member 68. In this manner, depending upon the threaded positional disposition of the adjustment screw 112 within the threaded section 114 of the end cap 102, the stroke of the valve mechanism, as predetermined by means of the degree to which the coil spring 120 is compressed between the valve mechanism piston member 68 and the flanged portion 118 of the adjustment screw 112, can be suitably adjusted.

As has been appreciated, the bead-type hot melt adhesive applicator nozzle assembly 26 is adapted to discharge and dispense hot melt adhesive materials which are obviously characterized by substantially elevated temperature levels. Accordingly, it can be readily appreciated still further that as the hot melt adhesive materials, characterized by such elevated temperature levels, are discharged and dispensed through means of the bead-type hot melt adhesive dispensing nozzle 10, which is fabricated from a suitable metal, such as, for example, brass, which exhibits high thermal conductivity, then the bead-type hot melt adhesive dispensing nozzle 10 will itself be heated to a substantially high degree. Accordingly, when it is desired or required to replace or exchange a particular one of the bead-type hot melt adhesive dispensing nozzles 10 with a new bead-type hot melt adhesive dispensing nozzle 10, such as, for example, when the bead-type hot melt adhesive dispensing nozzle 10 becomes operationally clogged, or when different bead dispensing characteristics are required, it is hazardous for personnel to contact and manipulate the particular bead-type hot melt adhesive dispensing nozzle 10, in view of the fact that the metal, substantially cup-shaped member 11 of the bead-type hot melt adhesive dispensing nozzle 10 has been heated to the aforenoted substantially elevated temperature levels, without the use of suitable protective gloves which are cumbersome, heavy, and bulky.

Therefore, in accordance with the unique and novel teachings and principles characteristic of the present invention, a protective ring member 122, fabricated from a suitable thermoplastic material which exhibits low thermal conductivity characteristics, such as, for example, a poly etheretherketone (PEEK) polymer, is fixedly mounted upon the external peripheral surface of the tubular wall member 14 portion of the substantially cup-shaped member 11 of the bead-type hot melt adhesive dispensing nozzle 10. More particularly, the protective ring member 122 may be fixedly mounted upon the external peripheral surface of the tubular wall member 14 portion of the substantially cup-shaped member 11 of the bead-type hot melt adhesive dispensing nozzle 10 by means of any suitable processing or technique, such as, for example, a press-fitting technique, an adhesive bonding procedure, or the like, such that the bead-type hot melt adhesive dispensing nozzle 10 and the protective ring member 122 effectively become an integral, one-piece assembly. In either case, the critically important characteristic of the present invention is that the new and improved bead-type hot melt adhesive dispensing nozzle 10, comprising the thermoplastic protective ring member 122 disposed around and fixedly mounted upon the tubular wall member 14 portion of the substantially cup-shaped member 11 of the bead-type hot melt adhesive dispensing nozzle 10, will enable operator or maintenance personnel to grasp, handle and manipulate the bead-type hot melt adhesive dispensing nozzle 10 without the need for the aforenoted heavy, bulky, and cumbersome work gloves.

In view of the fact that the thermoplastic material, from which the thermoplastic protective ring member 122 is fabricated, is effectively an insulator which exhibits low thermal conductivity, then a particular bead-type hot melt adhesive dispensing nozzle 10, which has been previously mounted upon the bead-type hot melt adhesive applicator nozzle assembly 26, which has already been used to dispense hot melt adhesive materials, and which therefore has already been heated to a relatively high temperature level, may nevertheless be readily, easily, quickly, and safely handled, manipulated, and removed from its threaded disposition upon the valve seat member 28 of the bead-type hot melt adhesive applicator nozzle assembly 26 without exposing maintenance or operator personnel to potential burn hazards. Similarly, a new, fresh, or different bead-type hot melt adhesive dispensing nozzle 10 may likewise be threadedly engaged upon the valve seat member 28 of the bead-type hot melt adhesive applicator nozzle assembly 26 without exposing the maintenance or operator personnel to any thermal safety hazards. More particularly, despite the fact that the new bead-type hot melt adhesive dispensing nozzle 10 may become heated to a relatively high temperature level in a relatively short period of time as a result of the exposure of the metal, substantially cup-shaped member 11 of the bead-type hot melt adhesive dispensing nozzle 10 to the heated environment of the bead-type hot melt adhesive applicator nozzle assembly 26, the provision and presence of the thermoplastic protective ring member 122 upon the outer peripheral surface portion of the tubular wall member 14 portion of the substantially cup-shaped member 11 of the bead-type hot melt adhesive dispensing nozzle 10 thermally protects the maintenance and operator personnel from potential burn hazards so as to permit the maintenance and operator personnel to perform their hot melt adhesive dispensing nozzle maintenance or exchange operations in a relatively easy, quick, and safe manner.

Thus, it may be readily appreciated that in accordance with the principles and teachings of the present invention, a new and improved bead-type hot melt adhesive dispensing nozzle, and a new and improved bead-type hot melt adhesive applicator nozzle assembly having the new and improved bead-type hot melt adhesive dispensing nozzle operatively incorporated thereon, has been disclosed, wherein the external peripheral surface portion of the bead-type hot melt adhesive dispensing nozzle has a thermal protective ring member, fabricated from a suitable plastic material, such as, for example, a polyetheretherketone (PEEK) polymer, fixedly mounted thereon. In this manner, maintenance or operator personnel can manually manipulate the bead-type hot melt adhesive dispensing nozzle without being exposed to potential burn and safety hazards. In addition, the need for such operator or maintenance personnel to wear heavy, bulky, or cumbersome gloves is obviated, and consequently, the operator or maintenance personnel can readily, rapidly, easily, and safely manually remove, for example, clogged bead-type hot melt adhesive dispensing nozzles from the bead-type hot melt adhesive applicator nozzle assemblies, and install new bead-type hot melt adhesive dispensing nozzles onto the bead-type hot melt adhesive applicator nozzle assemblies, in accordance with required or desired bead-type hot melt adhesive dispensing nozzle maintenance replacement or operational exchange procedures.

Obviously, many variations and modifications of the present invention are possible in light of the above teachings. It is therefore to be understood that within the scope of the appended claims, the present invention may be practiced otherwise than as specifically described herein.

1. A high-temperature fluid dispensing nozzle for use upon a high-temperature fluid dispensing applicator nozzle assembly for dispensing high-temperature fluids, comprising:
a fluid dispensing nozzle member fabricated from a metal material exhibiting relatively high thermal conductivity characteristics;
an axially oriented fluid dispensing port defined within said fluid dispensing nozzle member for dispensing high-temperature fluids therethrough; and
a thermoplastic ring member, fabricated from a plastic material exhibiting relatively low thermal conductivity characteristics and fixedly mounted upon an outer peripheral surface portion of said fluid dispensing nozzle member, for permitting operator personnel to grasp and manipulate said fluid dispensing nozzle member, in accordance with a fluid dispensing nozzle exchange operation, despite the elevated temperature level of said fluid dispensing nozzle member.

2. The high-temperature fluid dispensing nozzle as set forth in claim 1, wherein:
said fluid dispensing nozzle member has a substantially cup-shaped configuration-comprising a substantially planar plate portion, and a tubular wall portion integrally connected to said planar plate portion.

3. The high-temperature fluid-dispensing nozzle as set forth in claim 2, wherein:
said axially oriented fluid dispensing port is defined within said substantially planar plate portion of said fluid dispensing nozzle member; and
said thermoplastic ring member is fixedly mounted upon an external peripheral surface portion of said tubular wall portion of said fluid dispensing nozzle member.

4. The high-temperature fluid-dispensing nozzle as set forth in claim 1, wherein:
said fluid dispensing nozzle member is fabricated from brass; and
said thermoplastic ring member is fabricated from a polyetheretherketone (PEEK) polymer.

5. The high-temperature fluid-dispensing nozzle as set forth in claim 3, wherein:
said thermoplastic ring member is fixedly mounted upon said external peripheral surface portion of said tubular wall portion of said fluid dispensing nozzle member by means of a press-fitting operation so as to comprise, along with said fluid dispensing nozzle member, an integral one-piece assembly.

6. The high-temperature fluid-dispensing nozzle as set forth in claim 3, wherein:
said thermoplastic ring member is fixedly mounted upon said external peripheral surface portion of said tubular wall portion of said fluid dispensing nozzle member by means of an adhesive bonding operation so as to comprise, along with said fluid dispensing nozzle member, an integral one-piece assembly.

7. The high-temperature fluid dispensing nozzle as set forth in claim 2, wherein:
thread engagement means are provided upon an internal peripheral wall surface of said tubular wall portion of said fluid dispensing nozzle member for threaded engagement with the high-temperature fluid dispensing applicator nozzle assembly.

8. A hot melt adhesive dispensing nozzle for use upon a hot melt adhesive applicator nozzle assembly for dispensing hot melt adhesive material, comprising:
a hot melt adhesive dispensing nozzle member fabricated from a metal material exhibiting relatively high thermal conductivity characteristics;
an axially oriented hot melt adhesive dispensing port defined within said hot melt adhesive dispensing nozzle member for dispensing hot melt adhesive material there through; and
a thermoplastic ring member, fabricated from a plastic material exhibiting relatively low thermal conductivity characteristics and fixedly mounted upon an outer peripheral surface portion of said hot melt adhesive dispensing nozzle member, for permitting operator personnel to grasp and manipulate said hot melt adhesive dispensing nozzle member, in accordance with a hot melt adhesive dispensing nozzle exchange operation, despite the elevated temperature level of said hot melt adhesive dispensing nozzle member.

9. The hot melt adhesive dispensing nozzle as set forth in claim 8, wherein:
said hot melt adhesive dispensing nozzle member has a substantially cup-shaped configuration comprising a substantially planar plate portion, and a tubular wall portion integrally connected to said planar plate portion.

10. The hot melt adhesive dispensing nozzle as set forth in claim 9, wherein:
said axially oriented hot melt adhesive dispensing port is defined within said substantially planar plate portion of said hot melt adhesive dispensing nozzle member; and
said thermoplastic ring member is fixedly mounted upon an external peripheral surface portion of said tubular wall portion of said hot melt adhesive dispensing nozzle member.

11. The hot melt adhesive dispensing nozzle as set forth in claim 8, wherein:
said hot melt adhesive dispensing nozzle member is fabricated from brass; and
said thermoplastic ring member is fabricated from a polyetheretherketone (PEEK) polymer.

12. The hot melt adhesive dispensing nozzle as set forth in claim 10, wherein:
said thermoplastic ring member is fixedly mounted upon said external peripheral surface portion of said tubular wall portion of said hot melt adhesive dispensing nozzle member by means of a press-fitting operation so as to comprise, along with said fluid dispensing nozzle member, an integral one-piece assembly.

13. The hot melt adhesive dispensing nozzle as set forth in claim 10, wherein:
said thermoplastic ring member is fixedly mounted upon said external peripheral surface portion of said tubular wall portion of said hot melt adhesive dispensing nozzle member by means of an adhesive bonding operation so as to comprise, along with said fluid dispensing nozzle member, an integral one-piece assembly.

14. The hot melt adhesive dispensing nozzle as set forth in claim 9, wherein:
thread engagement means are provided upon an internal peripheral wall surface of said tubular wall portion of said hot melt adhesive dispensing nozzle member for threaded engagement with the hot melt adhesive dispensing applicator nozzle assembly.

15. A high-temperature fluid dispensing applicator nozzle assembly for dispensing high-temperature fluids, comprising:
a body member;
an intake port defined within said body member for introducing a high-temperature fluid into said body member;
a valve assembly operatively mounted upon said body member for movement between first CLOSED and second OPENED positions so as to respectively prevent and permit a high-temperature fluid to be discharged from said body member; and
a high-temperature fluid dispensing nozzle comprising a high-temperature fluid dispensing nozzle member fabricated from a metal material exhibiting relatively high thermal conductivity characteristics; an axially oriented fluid dispensing port defined within said fluid dispensing nozzle member and fluidically connected to said valve assembly for dispensing high-temperature fluids therethrough; and a thermoplastic ring member, fabricated from a plastic material exhibiting relatively low thermal conductivity characteristics and fixedly mounted upon an outer peripheral surface portion of said fluid dispensing nozzle member, for permitting operator personnel to grasp and manipulate said fluid dispensing nozzle member, in accordance with a fluid dispensing nozzle exchange operation, despite the elevated temperature level of said fluid dispensing nozzle member.

16. The high-temperature fluid dispensing applicator nozzle assembly as set forth in claim 15, wherein:
said fluid dispensing nozzle member has a substantially cup-shaped configuration comprising a substantially planar plate portion, and a tubular wall portion integrally connected to said planar plate portion.

17. The high-temperature fluid-dispensing applicator nozzle assembly as set forth in claim 16, wherein:
said axially oriented fluid dispensing port is defined within said substantially planar plate portion of said fluid dispensing nozzle member; and
said thermoplastic ring member is fixedly mounted upon an external peripheral surface portion of said tubular wall portion of said fluid dispensing nozzle member.

18. The high-temperature fluid-dispensing applicator nozzle assembly as set forth in claim 15, wherein:
said fluid dispensing nozzle member is fabricated from brass; and
said thermoplastic ring member is fabricated from a polyetheretherketone (PEEK) polymer.

19. The high-temperature fluid-dispensing applicator nozzle assembly as set forth in claim 17, wherein:
said thermoplastic ring member is fixedly mounted upon said external peripheral surface portion of said tubular wall portion of said fluid dispensing nozzle member by means of a press-fitting operation so as to comprise, along with said fluid dispensing nozzle member, an integral one-piece assembly.

20. The high-temperature fluid-dispensing applicator nozzle assembly as set forth in claim 17, wherein:
said thermoplastic ring member is fixedly mounted upon said external peripheral surface portion of said tubular wall portion of said fluid dispensing nozzle member by means of an adhesive bonding operation so as to comprise, along with said fluid dispensing nozzle member, an integral one-piece assembly.

21. The high-temperature fluid dispensing applicator nozzle assembly as set forth in claim 16, wherein:
thread engagement means are provided upon an internal peripheral wall surface of said tubular wall portion of said fluid dispensing nozzle member for threaded engagement with the high-temperature fluid dispensing applicator nozzle assembly.

22. A hot melt adhesive dispensing applicator nozzle assembly for dispensing hot melt adhesive, comprising:
a body member;
an intake port defined within said body member for introducing a hot melt adhesive into said body member;
a valve assembly operatively mounted upon said body member for movement between first CLOSED and second OPENED positions so as to respectively prevent and permit hot melt adhesive to be discharged from said body member; and
a hot melt adhesive dispensing nozzle comprising a hot melt adhesive dispensing nozzle member fabricated from a metal material exhibiting relatively high thermal conductivity characteristics; an axially oriented hot melt adhesive dispensing port defined within said hot melt adhesive dispensing nozzle member and fluidically connected to said valve assembly for dispensing hot melt adhesive there through; and a thermoplastic ring member, fabricated from a plastic material exhibiting relatively low thermal conductivity characteristics and fixedly mounted upon an outer peripheral surface portion of said hot melt adhesive dispensing nozzle member, for permitting operator personnel to grasp and manipulate said hot melt adhesive dispensing nozzle member, in accordance with a hot melt adhesive dispensing nozzle exchange operation, despite the elevated temperature level of said hot melt adhesive dispensing nozzle member.

23. The hot melt adhesive dispensing applicator nozzle assembly as set forth in claim 22, wherein:
said hot melt adhesive dispensing nozzle member has a substantially cup-shaped configuration comprising a substantially planar plate portion, and a tubular wall portion integrally connected to said planar plate portion.

24. The hot melt adhesive dispensing applicator nozzle assembly as set forth in claim 23, wherein:
said axially oriented hot melt adhesive dispensing port is defined within said substantially planar plate portion of said hot melt adhesive dispensing nozzle member; and
said thermoplastic ring member is fixedly mounted upon an external peripheral surface portion of said tubular wall portion of said hot melt adhesive dispensing nozzle member.

25. The hot melt adhesive dispensing applicator nozzle assembly as set forth in claim 22, wherein:
said hot melt adhesive dispensing nozzle member is fabricated from brass; and
said thermoplastic ring member is fabricated from a polyetheretherketone (PEEK) polymer.

26. The hot melt adhesive dispensing applicator nozzle assembly as set forth in claim 24, wherein:
said thermoplastic ring member is fixedly mounted upon said external peripheral surface portion of said tubular wall portion of said hot melt adhesive dispensing nozzle member by means of a press-fitting operation so as to comprise, along with said fluid dispensing nozzle member, an integral one-piece assembly.

27. The hot melt adhesive dispensing applicator nozzle assembly as set forth in claim 24, wherein:
said thermoplastic ring member is fixedly mounted upon said external peripheral surface portion of said tubular wall portion of said hot melt adhesive dispensing nozzle member by means of an adhesive bonding operation so as to comprise, along with said fluid dispensing nozzle member, an integral one-piece assembly.

28. The hot melt adhesive dispensing applicator nozzle assembly as set forth in claim 23, wherein:
thread engagement means are provided upon an internal peripheral wall surface of said tubular wall portion of said hot melt adhesive dispensing nozzle member for threaded engagement with said valve assembly.
